(19) United States
(12) Patent Application Publication
(10) Pub. No.: US 2002/0004910 A1
(43) Pub. Date: Jan. 10, 2002

(54) Network lock

(76) Inventors: Arno A. Penzias, San Francisco, CA (US); Glenn Ricart, Salt Lake City, UT (US)

Correspondence Address: KAPLAN & GILMAN , L.L.P., 900NROUTE 9 NORTH, WOODBRIDGE, NJ, 07095, US

(21) Appl. No.: 09/769,606

(22) Filed: Jan. 25, 2001

Related U.S. Application Data
(60) Provisional application No. 60/217,213, filed on Jul. 10, 2000.

(51) Int. Cl. G06F 11/30

(52) U.S. Cl. 713/201

(57) ABSTRACT

A method and system for limiting use of a computer apparatus when the apparatus is disconnected from a network. Under the method and system of the present invention, the computer apparatus will periodically contact a host or data center, via a network, to be updated, backed-up, enabled, re-enabled, disabled, etc. However, if the computer apparatus is being used beyond its predetermined time period or conditions of use, the apparatus can be automatically disabled without having to contact the host or data center via the network.

### RELATED APPLICATION

This application claims priority to Provisional No. 60/217,213 filed on Jul. 10, 2000.

### BACKGROUND OF THE INVENTION

1. Technical Field

The present invention relates to a method and system for limiting use of an apparatus, such as a computer or a device containing a computer, when the apparatus is disconnected from the network.

2. Background Art

As the use of computers and networks in the business grows, the need for service providers to be able to limit computer use increases. For example, in a computer network service business, a service provider might place a functional computer (or a device containing a functional computer) at a customer site. The computer (or device) is intended for use within a network, which may also be provided by the service provider. However, unless appropriate measures are taken, the computer will be capable of running stand-alone, namely, running disconnected from the network without the service provider being able to remotely limit its use. This possibility makes it difficult to ensure that events such as the following occur:

(a) The computer (or device) “calls home” periodically for software updates.

(b) The computer (or device) “calls home” periodically to backup information.

(c) If the computer (or device) were to be lost or stolen, it becomes useless to the thief.

(d) If the customer stops paying their bills, the machine becomes useless to them.

(e) A computer (or device) which has been reported to have a hardware problem and been replaced or a machine which is obsolete and replaced with a new one is not accidentally or surreptitiously put back into service.

(f) The service provider is notified about the amount and type of usage of the computer or the device in which it is embedded.

Accordingly, a system is needed that requires a network-locked machine to be periodically connected to the data center (e.g., to a CenterBeam data center) to keep running. Preferably, when the machine is connected, the data center personnel and/or equipment back up the machine's data, collect log and/or usage information, provide software updates, verify that the machine is not listed as lost or stolen, and verify that payment is current. The data center then “unlocks” it for another period of time, e.g., a week. That is, the computer hardware/software or the device in which it is embedded works standalone but must be periodically re-enabled or re-unlocked. This allows a service provider to remotely limit the computer's use.

### SUMMARY OF THE INVENTION

The present invention overcomes the deficiencies of the related art by providing a method and system for limiting use of an apparatus when the apparatus is disconnected from a network. Preferably, the apparatus will be required to periodically connect to a data center to, among other things, receive downloads, be backed-up, and exchange the necessary codes/information to remain enabled.

According to a first embodiment of the present invention, a method for limiting use of an apparatus such as a computer or a device containing a computer when the apparatus is disconnected from a network is provided. The method comprising the steps of: (1) determining when enablement or re-enablement of the apparatus is to be requested or required; (2) attempting to contact an enabling or re-enabling host or data center using a network connection; and (3) if the attempting step fails, disabling at least one capability of the apparatus for subsequent use or changing or modifying the functions the apparatus performs.

According to a second embodiment of the present invention a method for limiting use of an apparatus such as a computer or device containing a computer when the apparatus is disconnected from a network is provided. The method comprises the steps of: (1) determining when enablement or re-enablement of the apparatus is to be requested or required; (2) disabling at least one capability of the apparatus for subsequent use; (3) after said disabling, attempting to contact an enabling or re-enabling host or data center using a network connection; and (4) if the attempting step succeeds, enabling or re-enabling at least one capability of the apparatus for subsequent use.

According to a third embodiment of the present invention, a method for limiting use of an apparatus such as a computer or a device containing a computer when the apparatus is disconnected from a network is provided. The method comprises the steps of: (1) receiving at a data center or host a message from an apparatus requesting authorization of use or further use of at least one capability of the computer; (2) checking records to see if further use of the requesting apparatus should be authorized; and (3) if the records indicate that further use of the requesting apparatus should be authorized, sending an unlock message over a network connection to authorize further use of the requesting apparatus.

According to a fourth embodiment of the present invention, a method for limiting use of a computer apparatus is provided. The method comprises the steps of: (1) determining when enablement of a supplemental capability of the apparatus is required; (2) attempting to contact an enabling data center using a network connection; (3) if the attempting step fails, then avoiding enabling the supplemental capability of the apparatus; and (4) if the attempting step succeeds, then receiving enablement authorization from the data center and enabling the supplemental capability of the apparatus for subsequent use.

According to a fifth aspect of the present invention, a system comprising a re-enabling host or data center is provided. The apparatus comprises: (1) means for receiving at a data center or host a message from an apparatus requesting authorization of use or further use of at least one capability of the computer; (2) means for checking records to see if further use of the requesting apparatus should be authorized; and (3) means for sending an unlock message over a network connection to authorize further use of the requesting apparatus if the records indicate that further use of the requesting apparatus should be authorized.

The above and other details and objects of the invention will become clearer upon review of the following drawings and detailed description of the preferred embodiment.

### BRIEF DESCRIPTION OF THE DRAWINGS

FIG. 1 is a box diagram depicting one embodiment of a network lock according to the present invention.

It is noted that the drawing of the invention is not necessarily to scale. The drawing is merely a schematic representation, not intended to portray specific parameters of the invention. The drawing is intended to depict only one typical embodiment of the invention, and therefore should not be considered as limiting the scope of the invention. In the drawing, like numbering represents like elements.

### DETAILED DESCRIPTION OF THE DRAWINGS

As indicated above, the present invention provides a method and system for limiting use of an apparatus, such as a computer or device containing a computer, when the apparatus is disconnected from a network (e.g., stand alone).

The concepts of the present invention may be applied to many scenarios. One example is renting a car. Specifically, a rental car should be periodically taken back to the car rental agency to change its oil, apply any factory recalls, etc. Although contractual obligations for returning the car can be agreed on, there is no technical requirement that the car be taken back. The car will continue to start and run even if it is not taken back after the expiration of the agreed rental period. Applying concepts of the present invention, the car could contain a functional computer, which could use a wireless network lock. The lock would flash a message or disable the car if it is away from the rental agency beyond a prescribed time period. If the driver called the rental agency and said he or she wanted it for another week, and the rental agency agreed, the car could wirelessly check the network lock at the end of the agreed rental period and be “unlocked” or “re-enabled” by the rental agency for an additional week.

One method for implementing the network lock for the rental car includes a combination lock whose correct combination changes at regular intervals in ways understood by its manufacturer and the car rental agency but not by the renter or driver. This combination lock is installed in the car so the current correct combination must be entered to open the car's doors. To “unlock” or “re-enable” the car for an additional period of time, the car rental agency transmits to the car and to the renter the current combination along with the length of additional time (or distance) the car is allowed to operate before being unlocked again. Although there are many ways to create such a combination lock in computer software, one method is to use a pseudo-random number generator with only some of the digits of the number generator constituting the correct combination.

In addition to the car staying unlocked for a period of time represented by the rental agreement, the car could also require extra network unlocking codes for specific uses, such as being driven across a zone, state, or national border. This could be enforced using a global positioning system to determine the car's location, so that the car is disabled at or near a national border unless the renter/driver contacts the rental agency and obtains authorization to use the car in the neighboring country.

Note that network access services like AOL would not normally need a network lock. Because the services they deliver are network-delivered, they can simply cut off services at the network level. Rather, the network lock is needed when the service delivery device or system is (at least partly) usable in a stand-alone mode.

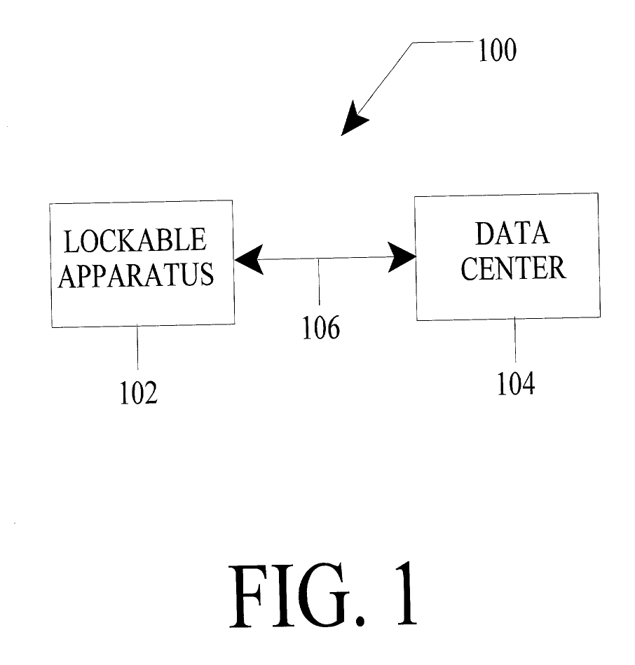

Referring to FIG. 1, a preferred embodiment of a network lock 100 according to the present invention is shown. The network lock 100 generally includes three main components, namely, an apparatus (computer or device) 102, a data center 104, and a network connection 106 between the apparatus 102 and the data center 104. The lockable apparatus 102 is a service-delivering device provided by the service provider; the apparatus 102 is capable of running at least partly in a stand-alone mode unless that capability is completely disabled by the invention. The network lock of the present invention may be used in computers 102 such as network clients, which normally operate on-line and/or in computers 102 such as laptops and/or desktops, that will work stand-alone if they can't contact a network.

The service provider wishes to enforce a policy that after some period of time or in order to perform certain actions or functions, apparatus 102 must be enabled or re-enabled by the service provider's data center 104. This is done over a network connection 106 of some type (wired, Internet, wireless, direct dial-up, etc.). The apparatus 102 is configured with software and/or hardware such that if the apparatus 102 is not enabled or re-enabled, it can take one or more of a set of limiting or disabling actions such as:

(a) requesting to be re-connected to the service provider;

(b) demanding to re-connected to the service provider before providing additional services;

(c) warning it will shut itself down if not re-connected to the service provider;

(d) providing only limited services until re-connected to the service provider;

(e) operating in a different mode or style;

(f) shutting down until re-connected to the service provider;

(g) steps (d), (e), and (f) may include, e.g., ignoring user input, refusing file access, refusing disk access, encrypting data, refusing access to operating system functionality, refusing access to peripheral devices, and/or taking other steps to disable, limit, or change functionality; and/or

(h) not providing additional functions requested.

Accordingly, this facilitates:

(a) keeping apparatus 102 up-to-date with fixes, changes, and features;

(b) providing for backup of critical information that may be stored only on apparatus 102;

(c) determining the amount and/or type of usage of apparatus 102 (particularly in a situation where payment for the service is usage-based);

(d) making apparatus 102 with the present invention useless to thieves; and/or

(e) prompting the users of apparatus 102 to keep payments to the service provider current.

How often the network locked apparatus 102 must be enabled or re-enabled depends upon the use to which the present invention is put. Without limitation, we envision any combination of the following criteria for determining when enablement or re-enablement is requested or required for further use of one or more capabilities of the box 102:

(a) a predetermined period of time has elapsed;

(b) a predetermined amount of usage of the apparatus 102 has occurred;

(c) a special function is to be performed with the apparatus 102, e.g., installing a new software program or being driven across a national border;

(d) when the apparatus 102 detects a possible problem, such as when a wrong password has been entered three times in a row;

(e) when it passes a re-enabling point in the physical surroundings, e.g., an airport security checkpoint that's been instrumented by the service provider; and/or

(f) when a user's ordinary credentials cannot be verified, e.g., a voice pattern recognition is failing due to the user having a cold and sore throat.

Mechanisms to implement the inventive network lock include software and/or hardware configuring conventional machines to operate as described herein. In one embodiment, apparatus 102 uses a standard network connection 106 to contact the service provider's host or data center 104. Apparatus 102 identifies itself by sending a message only it could send, for example, by using public/private key pairs and encrypting a message in its own private key. It may optionally include information about the last time it was re-enabled, its usage since then, its location, special requests being made of the apparatus, the configuration of hardware and/or the version(s) of software it has, information on hardware updates, and other profiling or usage information.

Host or data center 104 checks its records to see if apparatus 102 is eligible for continued service or eligible to perform a special function that has been requested. Host or data center 104 then sends an unlock message only it can send (for example, by encrypting the message in a private key known only to the service provider's host or data center) over connection 106 to apparatus 102. Upon verifying the validity of the unlock message (for example, by decrypting it successfully using the public key of the service provider), apparatus 102 is unlocked for a future period of time and/or events and/or functions.

To improve the security and sureness of this process, one or more of the following additional measures may be taken:

(a) The apparatus 102 is configured so that the clock on apparatus 102 cannot be reset except by a verified message from service provider's host or data center 104.

(b) The unlocking mechanism is encoded into the apparatus 102 BIOS, where it is very difficult to change or defeat.

(c) The unlocking mechanism is encoded into a security attachment (generically called a “dongle” in the trade) to one of the apparatus' computer ports (USB, parallel, serial, keyboard, mouse, network, etc.).

(d) Each re-enablement message contains information that is needed to trigger or verify the following re-enablement.

(e) The enablement or re-enablement mechanism depends on receiving information (such as a changing combination lock number) which is verified by a hardware device.

(f) The enablement or re-enablement mechanism depends on receiving information which completes a “puzzle” the apparatus attempts to solve.

(g) A box 102 being decommissioned may be stripped of its enabling codes or mechanisms.

The inventive network lock software (or a portion thereof) may be embodied in a configured storage medium. Suitable configured storage media include magnetic, optical, or other computer-readable storage devices having specific physical substrate configurations. Suitable storage devices include diskettes, Iomega Zip disks, hard disks, tapes, CD-ROMs, PROMs, RAM, and other computer system storage devices. The substrate configuration represents data and instructions, which cause the apparatus 102 and/or data center host 104 to operate in a specific and predefined manner as described herein.

Thus, in some cases the medium tangibly embodies a program, functions, and/or instructions that are executable by a lockable apparatus 102 to perform steps of the present invention substantially as described herein, such as determining when re-enablement of the apparatus 102 is to be requested or required; attempting to contact the re-enabling host or data center 104 using the network connection 106; and if the attempting step fails, disabling at least one capability of the apparatus 102 for subsequent use. Alternatively, the apparatus 102 may disable some or all of its own functionality before attempting to contact data center 104, and re-enable that functionality only if the host 104 authorizes it to do so.

In other cases the medium tangibly embodies a program, functions, and/or instructions that are executable by a data center host 104 to perform steps of the present invention substantially as described herein to see if apparatus 102 is eligible for continued service, such as checking its records to see if apparatus 102 is known to be stolen or lost, checking its records to see if the user of apparatus 102 is in payment arrears, and sending an unlock message over the connection 106 to authorize re-enablement of the apparatus 102.

Although particular systems and methods embodying the present invention are expressly illustrated and described herein, it will be appreciated that apparatus, signal, and article embodiments may also be formed according the present invention. Unless otherwise expressly indicated, the description herein of any type of embodiment of the present invention therefore extends to other types of embodiments in a manner understood by those of skill in the art.

The invention may be embodied in other specific forms without departing from its essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. A method for limiting use of an apparatus such as a computer or a device containing a computer when the apparatus is disconnected from a network, comprising the steps of:
determining when enablement or re-enablement of the apparatus is to be requested or required;
attempting to contact an enabling or re-enabling host or data center using a network connection; and
if the attempting step fails, disabling at least one capability of the apparatus for subsequent use or changing or modifying the functions the apparatus performs.

2. A method for limiting use of an apparatus such as a computer or device containing a computer when the apparatus is disconnected from a network, comprising the steps of:
determining when enablement or re-enablement of the apparatus is to be requested or required;
disabling at least one capability of the apparatus for subsequent use;
after said disabling, attempting to contact an enabling or re-enabling host or data center using a network connection; and
if the attempting step succeeds, enabling or re-enabling at least one capability of the apparatus for subsequent use.

3. A method for limiting use of an apparatus such as a computer or a device containing a computer when the apparatus is disconnected from a network, comprising the steps of:
receiving at a data center or host a message from an apparatus requesting authorization of use or further use of at least one capability of the computer;
checking records to see if further use of the requesting apparatus should be authorized; and
if the records indicate that further use of the requesting apparatus should be authorized, sending an unlock message over a network connection to authorize further use of the requesting apparatus.

4. The method of claim 3, wherein the checking step checks records to see if the requesting apparatus is known to be stolen or lost, and wherein further use is not authorized if the records indicate that the requesting apparatus is known to be stolen or lost.

5. The method of claim 3, wherein the checking step checks records to see if the last known user of the requesting apparatus is in payment arrears, and further use is not authorized if the records indicate that the authorized user of the requesting apparatus is in payment arrears.

6. A system comprising an apparatus, which is disconnectable from a network, the apparatus comprising means for performing the steps of claim 1 or claim 2.

7. A system according to claim 6, further comprising the re-enabling host or data center.

8. A system comprising a re-enabling host or data center, the apparatus comprising means for performing the steps of any of claims 3 through 5.

9. A system according to claim 8, further comprising the requesting apparatus.

10. A configured storage medium embodying data and instructions readable by at least one computer to perform the method of any of claims 1 through 5.

11. A method for limiting use of a computer apparatus, comprising the steps of:
determining when enablement of a supplemental capability of the apparatus is required;
attempting to contact an enabling data center using a network connection;
if the attempting step fails, then avoiding enabling the supplemental capability of the apparatus; and
if the attempting step succeeds, then receiving enablement authorization from the data center and enabling the supplemental capability of the apparatus for subsequent use.

12. The method of claim 11, wherein the enabling step enables use of a rental car after the car crosses a state or national border.

13. The method of claim 11, wherein the determining step determines that a supplemental capability of a rental car is needed by using a global positioning system to locate the rental car relative to a predefined border.

14. The method of claim 11, wherein the attempting step succeeds in contacting the enabling data center but does not succeed in receiving supplemental capability enablement authorization from the data center, and the supplemental capability is not enabled.

15. The method of claim 14, wherein the apparatus is a rental car and the car is disabled near a national border in response to the lack of supplemental capability enablement authorization.
